(19) United States
(12) Patent Application Publication
(10) Pub. No.: US 2004/0057076 A1
(43) Pub. Date: Mar. 25, 2004

(54) Operation-screen display device, method, and recording medium containing a program for display of an operation-screen

(75) Inventors: Akira Hirose, Kawasaki-shi (JP); Tadahiko Ikegaya, Kawasaki-shi (JP); Tadao Michimura, Kawasaki-shi (JP); Keiko Shiraishi, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/414,216

(22) Filed: Apr. 16, 2003

(30) Foreign Application Priority Data
Sep. 20, 2002 (JP) 2002-275229

(51) Int. Cl. B41F 1/00; G06F 15/00

(52) U.S. Cl. 358/1.16; 358/1.15

(57) ABSTRACT

When a user selects a job order, a job-order analysis section analyzes the job order and supplies required information to a UI generation section and a parameter management section. Data of a scanning operation screen which has been stored beforehand is read out in the UI generation section for a “scan” operation described in the job order, as a type is “scan” indicating a function which has been provided in a multiple function device beforehand. Moreover, the parameter value of “color” on the scanning operation screen is set as “true” in the UI generation section, as the default value of “color” in the job order is “true”. A control panel displays the scanning operation screen generated in the UI generation section.

### BACKGROUND OF THE INVENTION

1. Field of the Invention

The present invention relates to a device, a method and a recording medium containing a program for display of an operation screen, and, more particularly, to a device, a method and a recording medium containing a program for display of an operation screen, which are preferably used for a document processing network system in which paper documents and electronic information are used in a mixed manner.

2. Description of the Related Art

Conventionally, a multiple function device in which functions as a fax machine, a scanner and a printer are incorporated into one copying machine has been proposed. Thereby, administrative processing which mainly uses paper with a copying machine, a fax machine and the like and electronic document processing on a personal computer may be linked.

Specifically, a paper document may be scanned for transfer to a personal computer, or a document received by facsimile may be transmitted without printing to a personal computer as image data. Furthermore, a lot of procedures and many pieces of processing have been required to be linked for automation after electronic processing of paper documents and received facsimile documents.

Therefore, there has been conventionally proposed a technology by which job templates in which desired setting for items to be set in a multiple function device is described have been prepared beforehand, one of the job templates is specified and processing is executed after set values are changed as required.

For example, in a conventional image forming device, a plurality of output setting data with which output formats are set are saved, and an image in an output format according to a selected output setting data is formed and output (refer to, for example, a patent document 1 (Japanese Patent Application Laid-open (JP-A) No. 10-83263, pp. 5 to 7, FIGS. 2 and 5)).

Also, an image reading system, which comprises at least one image reading device and in which an image is read and transferred from the image reading device to other devices, has been conventionally proposed (refer to, for example, a patent document 2 (JP-A No. 2000-270148)).

In such an image reading system, the image reading device reads an image according to reading conditions described in a job template and transmits a file of a read image to other devices.

Here, a processing command for the read image may be further described in the job template. In this case, the other devices may interpret the processing command described in the job template and processing may be executed according to the command. Also, the image reading device may display the contents described in the job template and is able to accept changes in the described contents by a user.

Moreover, a transfer end of the image may be further described in the job template. In this case, the image reading device may display candidates of transfer ends in a tree-structure state when the transfer end is set or changed.

Also, a conventional image processing device may customize specifications of an operation screen according to the content which is set by a user and described in a common setting file (refer to, for example, a patent document 3 (JP-A No. 2001-306204)).

Generally, a user interface for a multiple function device has had no expandability, as items and behaviors are fixed. Accordingly, it has been difficult to add instructions and input items, which are required for operation, in the case of later linking with electronic processing on a personal computer. Then, the benefit and the convenience of the system have been reduced, or inconvenience have been forced, for example, a plurality of user interface devices have been required to be operated when consecutive pieces of processing are executed.

For example, the image forming device disclosed in the patent document 1 has only a “output format”, that is, a function for the relevant device itself as an object to be set. Accordingly, the above-described image forming device has not been able to execute setting for other devices such as a printer or a scanner which are connected to a network. Moreover, the above-described image forming device has been unable to correct and change the contents of the output setting data at execution.

In the image reading system disclosed in the patent document 2, the image reading device may display the contents described in the job template and accept changes in the described contents by a user. However, when a new device is added to the system, the image reading device has had a problem that the new device may not be controlled unless a job template is not changed.

In the image forming device disclosed in the patent document 3, the operability, that is, environments for input operation may be configured to be portable among devices of the same kind or different sorts. However, the above-described image forming device has had a problem that a requirement to add a new necessary operation screen for change may not be satisfied when a new system linked with other devices is made

### SUMMARY OF THE INVENTION

The present invention has been proposed in order to solve the above problems and its object is to provide a device, a method, and a recording medium containing a program for display of an operation screen, by which the operation screen is displayed according to a change, even when there is the change in a system configuration or a processing content.

A first aspect of the invention provides an operation-screen display device comprising: a job-order storage section which stores a job order, in which processing information by which one or more pieces of processing applied to document data are expressed as consecutive pieces of processing, and one or more parameters which respectively set an execution content of each of the pieces of processing are described; and an operation-screen display section which displays an operation screen in order to set at least one parameter which is described in the job order stored in the job-order storage section.

A sixth aspect of the invention provides an operation-screen display method comprising: a job-order storage step of storing a job order in which processing information expressing one or more pieces of processing applied to document data as consecutive pieces of processing, and one or more parameters which respectively set an execution content of each of the pieces of processing are described; and an operation screen display step of displaying an operation screen in order to set at least one parameter which is described in the job order stored at the job-order storage step.

An eleventh aspect of the invention provides a recording medium containing an operation-screen display control program for causing a computer to execute processing comprising an operation screen display step of displaying an operation screen based on a job order which describes processing information expressing one or more pieces of processing applied to document data as consecutive pieces of processing, and one or more parameters which respectively set an execution content of each of pieces of processing, in order to set at least one parameter which is described in the job order.

Here, inventions according to the first and sixth aspects of the invention may be realized by installing the operation-screen display control program according to the eleventh aspect of the invention in a computer.

Processing information by which one or more pieces of processing to be applied to document data are expressed as consecutive pieces of processing and a parameter which sets the execution content of each processing are described in a job order stored in the job-order storage section. Here, the document data may be information related with sentences and, for example, character information such as text data and image information such as images read from a paper document may be applied. But, it is not especially limited to the above ones. The processing information expresses one or more pieces of processing, which are applied to the document data, as consecutive pieces of processing and indicates linking between pieces of processing related with the document data. The parameters which set the execution contents of pieces of processing may be set as default values which have been predetermined beforehand or may be values obtained by request.

In the operation-screen display section, an operation screen is displayed in order to set at least one parameter which has been described in the job order stored in the job-order storage section. Here, it is preferable that the operation-screen display section comprises a so-called touch panel.

Therefore, operation screens can be customized and operation screens with superior expandability may be presented according to the first, sixth and eleventh aspects of the invention, as the operation screens are displayed in order to set at least one parameter, based on a job order in which processing information by which one or more pieces of processing applied to document data are expressed as consecutive pieces of processing and a parameter which sets the execution content of each processing.

A second aspect of the invention an operation-screen display device according to the first aspect of the invention, further comprising: a parameter setting section which Bets a parameter described in the job order through the operation screen displayed on the operation-screen display section; and a processing execution section which executes the processing based on the job order which has been stored in the job-order storage section and on the parameter set in the parameter setting section.

A seventh aspect of the invention provides an An operation-screen display method according to claim 6, further comprising: a parameter setting step of setting a parameter described in the job order through the operation screen displayed at the operation screen display step; and a processing execution step of executing the processing based on the job order stored at the job-order storage step and on the parameter set at the parameter setting step.

A twelfth aspect of the invention provides an operation-screen display control program according to the eleventh aspect of the invention, wherein the program causes a computer to execute processing which further comprises: a parameter setting step of setting a parameter described in the job order through the operation screen displayed at the operation screen display step; and a processing execution step of executing the processing based on the job order and on the parameter set at the parameter setting step.

The parameter setting section sets the parameter described in the job order through the operation screen displayed on the operation screen display step according to operations by a user. The parameter setting section is not limited to a special one, but, for example, the section may be a so-called touch panel or a button.

The above-described processing is executed in the processing execution section, based on the job order which has been stored in the job-order storage section and on the parameter set in the parameter setting section. Here, the processing execution section may be one in which hardware processing of a scanner, a printer, and the like is executed, or in which software processing of image processing, and the like is performed.

Therefore, processing may be executed so that the intention of a user is reflected on the processing according to the second, seventh, and twelfth aspects of the invention, as the user may set a parameter to execute consecutive pieces of processing through the operation screen.

A third aspect of the invention provides a job-order storage section according to the first and second aspects, claim 1, wherein: the job-order storage section stores the job order in which layout information for the operation screen is further described; and the operation-screen display section displays the operation screen based on the layout information of the job order.

An eighth aspect of the invention provides an operation-screen display method according to the sixth and seventh aspects of the invention, wherein: the job order in which layout information for the operation screen is further included is stored at the job-order storage step; and the operation screen is displayed at the operation-screen display step based on the layout information of the job order.

A thirteenth aspect of the invention provides an operation-screen display control program according to the eleventh and twelfth aspects of the invention, wherein the operation screen is displayed at the operation-screen display step based on the job order in which layout information for the operation screen is further described.

Therefore, one or more pieces of processing applied to document data are executed as consecutive pieces of processing and moreover, an operation screen to set a parameter related with the related consecutive pieces of processing may be easily displayed according to the third, eighth, and thirteenth aspects of the invention.

A fourth aspect of the invention provides an operation-screen display device according to the second or third aspect of the invention further comprising: a job-order updating section which updates the job order based on a result of the processing executed by the processing execution section; and a job-order transfer section which transfers the job order that has been updated by the job-order updating section to an execution location of a next piece of processing.

A ninth aspect of the invention provides an operation-screen display method according to the seventh or eighth aspect of the invention further comprising: a job-order updating step of updating the job order based on a result of the processing executed at the processing execution step; and a job-order transfer step of transferring the job order updated at the job-order updating step to an execution location of a next piece of processing.

A fourteenth aspect of the invention provides an operation-screen display control program according to the twelfth or thirteenth aspect of the invention, wherein the program makes a computer execute processing which further comprises: a job-order updating step of updating the job order based on a result of the processing executed at the processing execution step; and a job-order transfer step of transferring the job order updated at the job-order updating step to an execution location of a next piece of processing.

The job order is updated in the job-order updating section in order to reflect the execution result of the processing execution section on the job order in the command, for example, by writing the parameter obtained by execution in the processing execution section into the job order, or by deleting information on processing which has been completed.

The job-order transfer section transfers the job order updated in the job-order updating section to an execution end to be processed in the next place. Here, the execution end to be processed in the next place may be, for example, the inside of the present device itself or an external processing device.

Therefore, consecutive pieces of processing may be executed not only in the present device, but also in association with the external processing device by transferring the job order on which the processing result of the present device has been reflected to the external processing device according to the fourth, ninth, and fourteenth aspects of the invention.

A fifth aspect of the invention provides an operation-screen display device according to any one of the first through fourth aspects of the invention further comprising: a model storage section which stores a model of the job order; an external-processing-information receiving section in which receives external processing information expressing a content of processing which is applied to document data by a processing device; and a job-order generation section which generates the job order through which consecutive pieces of processing are executed in association with the processing device based on the model stored in the model storage section and the external processing information received by the external-processing-information receiving section.

A tenth aspect of the invention provides an operation-screen display method according to any one of the sixth through ninth aspects of the invention further comprising: an external processing information receiving step of receiving external processing information expressing a content of processing applied to document data by a processing device is received; and a job-order generation step of generating a job order through which consecutive pieces of processing are executed in association with the processing device based on a model stored in advance and the external processing information received at the external-processing-information receiving step.

A fifteenth aspect of the invention provides an operation-screen display control program according to any one of the eleventh through fourteenth aspects of the invention, wherein the program a makes a computer execute processing which further comprises: an external-processing-information receiving step of receiving external processing information expressing a content of processing applied to document data by a processing device; a job-order generation step of generating the job order through which consecutive pieces of processing are executed in association with the processing device based on a model stored in advance and the external processing information received at the external-processing-information receiving step.

The model of the job order, that is, the description format of the job order is stored in the model storage section. The external-processing-information receiving section receives the external processing information expressing the content of the processing which is applied to document data by a processing device. The job order, through which consecutive pieces of processing are executed in association with the processing device is generated, based on the model and the external processing information.

Therefore, according to the fifth, tenth, and fifteenth aspects of the invention, the operation screen with superior expandability may be displayed, based on the job order which has been made after external processing information is received from the outside processing device, even in a case in which the processing content of the external processing device is not specified.

### BRIEF DESCRIPTION OF THE DRAWINGS

FIG. 1 is a block diagram showing a configuration of a document processing network system according to a first embodiment of the present invention.

FIG. 2 is a block diagram showing a functional configuration of a multiple function device.

FIG. 3 is a view showing a menu screen displayed on a control panel.

FIG. 4 is a view showing a job order made in an XML format.

FIG. 5 is a view showing a DB registration operation screen.

FIG. 6 is a view showing the DB registration operation screen when a tab for a document registration operation screen is selected.

FIG. 7 is a flow chart showing a processing procedure by which the document registration operation screen is made in a UI generation section.

FIG. 8 is a block diagram showing a functional configuration of a multiple function device according to a second embodiment.

FIG. 9 is a view showing a job order, which is made in an XML format, according to the second embodiment.

FIG. 10 is a view showing an error message 61 displayed on the DE registration operation screen.

FIG. 11 is a block diagram showing a functional configuration of a multiple function device according to a third embodiment.

FIG. 12 is a view showing a job order, which is made in an XML format, according to the third embodiment.

FIG. 13 is a flow chart showing a processing procedure by which the job order is updated in job-order updating section.

FIG. 14 is a view showing the job order, which is rewritten in the job-order updating section.

FIG. 15 is a block diagram showing a functional configuration of a multiple function device according to a fourth embodiment.

FIG. 16 is a view showing external service information.

FIG. 17 is a view showing the model of a job order.

FIG. 18 is a view showing a job order generated in a job-order composition section.

### DETAILED DESCRIPTION OF THE PREFERRED EMBODIMENTS

Hereinafter, preferable embodiments according to the present invention will be explained in detail, referring to drawings.

[First Embodiment]

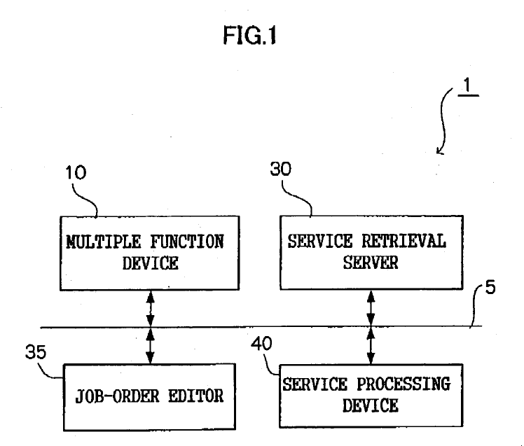

FIG. 1 is a block diagram showing a configuration of a document processing network system 1 according to a first embodiment of the invention.

In the document processing network system 1, various kinds of services and applications are linked to each other through a network 5. Here, the services means functions which can be used with regard to documents, responding to requirements from the outside. For example, copying, printing, scanning, transmitting and receiving by facsimile, delivery of electronic mails, saving and reading into and from a repository, OCR (optical Character Recognition) processing, noise rejection processing may be applied as the services.

The document processing network system 1 specifically comprises: a multiple function device 10 in which services such as copying, printing, scanning, and a facsimile service are executed; service retrieval server 30 through which a user retrieves a desired service; a job-order editor 35 in which a job order is made; and a service processing device 40 in which predetermined service processing is executed.

Though the above-described document processing network system 1 has a configuration in which a plurality of servers or devices in which pieces of predetermined service processing are executed are connected to each other through the network 5, the system 1 is not limited to the above configuration, if a plurality of services are linked through the network 5. Furthermore, the number of the service processing devices is, not limited.

Here, the job order means a file which comprises information expressing relations among functions and information (interface information) through which the functions are called when successive pieces of processing are decomposed into plural pieces of functional processing. In addition, pieces of information which express graphic user interfaces (GUIs) for the successive pieces of processing may be included.

Also, the linking means that there are relations between services, for example, that the result of a certain service decides a service which starts afterwards, or exerts influences on operations of services which start afterwards.

The multiple function device 10 is one of service processing devices and mainly executes scanning, Furthermore, the multiple function device 10 has a linking starting function by which job orders are selected responding to operations by users, parameters are input, the input parameters are reflected in the job orders, and, then, starting of linking processing is required.

The service processing device 40 may be a copying device, a facsimile device, a server or, a personal computer in which document data are processed in a predetermined manner. Furthermore, the device 40 is not especially limited to the above ones.

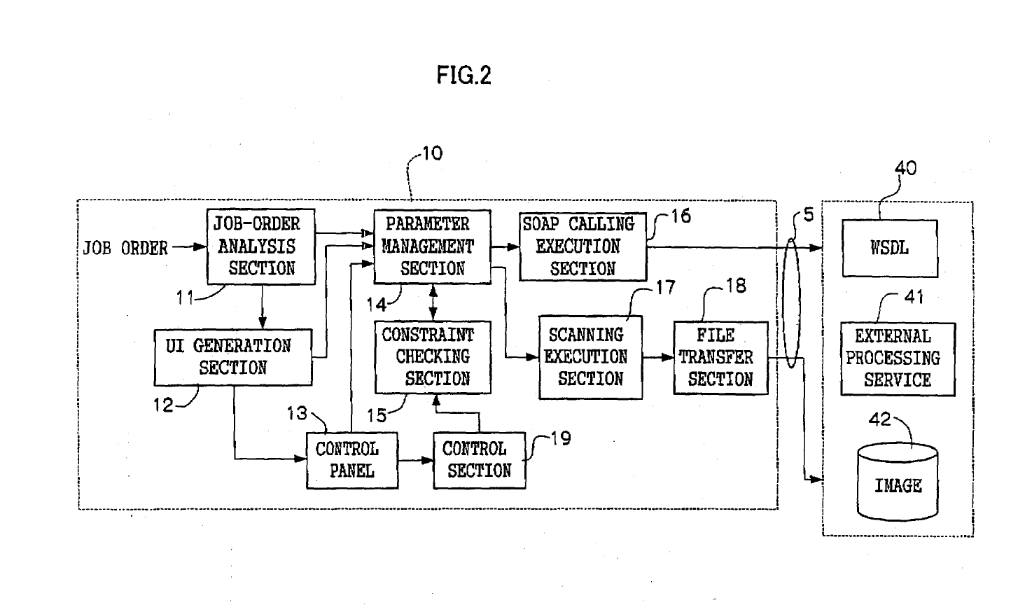

FIG. 2 is a block diagram showing a functional configuration of the multiple function device 10.

The multiple function device 10 comprises: an job-order analysis section 11 in which a job order is first stored and analyzed thereafter; a UI (user interface) generation section 12 in which a UI is generated based on the job order; a control panel 13 in which the UI which has been generated in the UI generation section 12 is displayed and an operation input by a user is received; a parameter management section 14 in which parameters are stored and managed; a constraint checking section 15 in which constraints for the parameters which have been stored in the parameter management section 14 are checked; a SOAP (Simple Object Access Protocol) calling section 16; a scanning execution section 17 in which scanning is executed; a file transfer section 19 by which document data obtained by scanning is transferred; and a control section 19 in which overall control is executed.

Also, the service processing device 40 comprises: an external processing service section 41 in which predetermined service processing is executed; and a data storage section 42 in which images, job orders, and the like are stored.

Here, the control panel 13 of the multiple function device 10 displays a menu screen which comprises a basic menu based on a UI which has been set in the main body of the multiple function device beforehand and a job-order menu based on the UI which has been generated in the UI generation section 12.

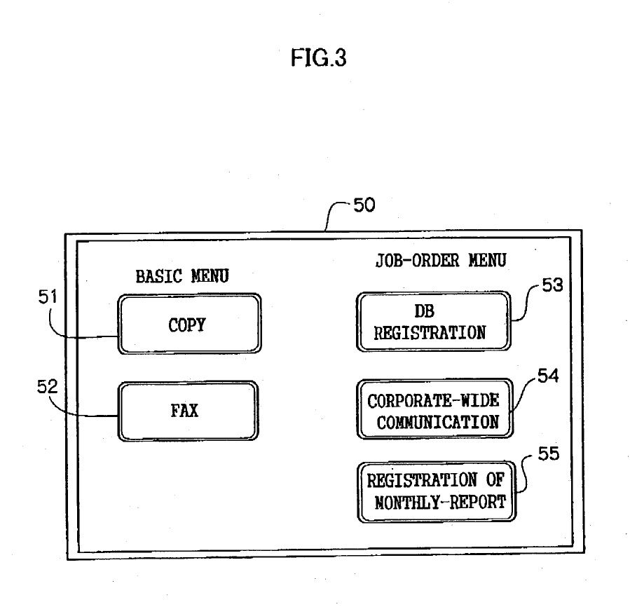

FIG. 3 is a view showing a menu screen 50 displayed on the control panel 13. The basic menu is a menu through which a user selects a desired service from a plurality of services which have been set in the multiple function device 10 beforehand. The job-order menu is a menu through which a user selects a desired service from a plurality of job orders.

The menu screen 50 comprises as a basic menu through which functions, which may be executed in the main body of the multiple function device, are selected; a copy button 51 through which a copying function is selected; and a FAX button 52 through which a facsimile transmission function is selected. Moreover, the menu screen 50 comprises as a job-order menu: a DB registration button 53 through which registration of files in a predetermined external data base is selected; a corporate-wide communication button 54; and a monthly-report registration button 55. Here, the menu screen 50 is not limited to the one shown in FIG. 3, and the screen 50 can be changed according to the functions of the multiple function device 10 or the contents of a plurality of services which have been described in the job orders.

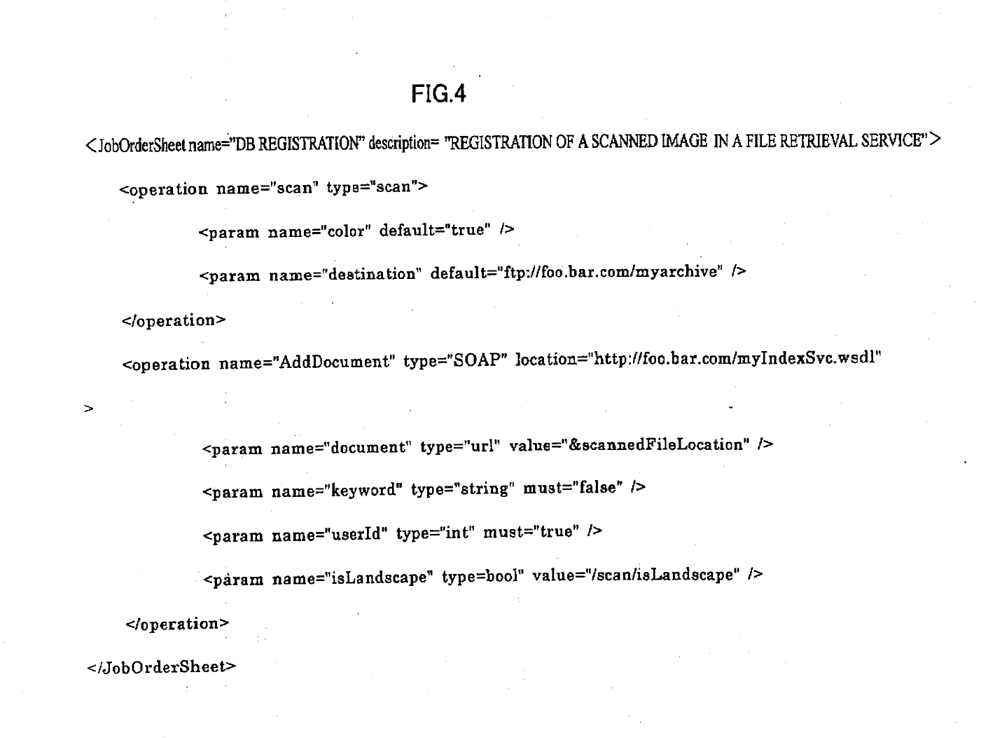

FIG. 4 is a view showing a job order made in an XML (extensible Markup Language) format. According to the above job order, processing is executed by selecting the DB registration button 53 and, then, the below-described start button 92. Here, the job order may be made in various formats other than the XML format not only in the present embodiment, but also in the below-described second through fourth embodiments.

The job order is intended to be used to scan some paper in the multiple function device 10 and then to store the acquired image document in the service processing device 40 in which documents are saved in a retrievable manner. Here, the job order expresses, as shown in FIG. 4, that two services, a “scan” operation and a “AddDocument” operation are executed in the above-written order.

The “scan” operation has two parameters of “color” and “destination”. The “AddDocument” operation has four parameters of “document”, “keyword”, “userId” and “isLandscape”.

(Display of the DB Registration Operation Screen)

The control panel 13 displays a DB registration operation screen on the multiple function device 10 in the document processing network system 1 with the above-described configuration when the DB registration button 53 is selected.

FIG. 5 is a view showing a DB registration operation screen 6. The DB registration operation screen 60 is displayed when the DB registration button 53 is selected using the control panel 13. The DB registration operation screen 60 comprises: a scanning operation screen 70 through which a parameter for a scanning service is set; a document registration operation screen 80 through which document registration is set: a cancellation button 91 through which cancellation for execution according to the job order is instructed; and a start button 92 through which starting of execution according to the job order is instructed.

Accordingly, the DB registration operation screen 60 comprising the scanning operation screen 70 and the document registration operation screen 80 is displayed on the control panel 13. Here, a user may switch the display screen between two screens by touching a tab for the scanning operation screen 70 or one for the document registration operation screen 80.

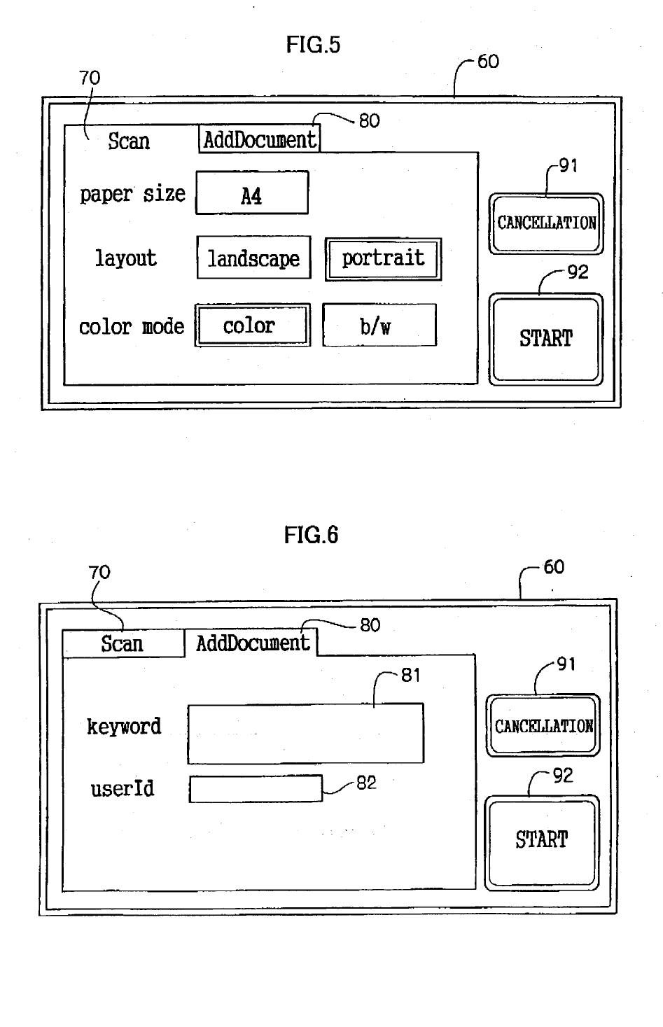

FIG. 6 is a view showing the DB registration operation screen 60 when the tab for the document registration operation screen 80 is selected. The document registration operation screen 80 has a keyword input field 81 and a userID field 82.

(Generation of Scanning operation Screen 70)

The scanning operation screen 70 is generated as follows based on the job order shown in FIG. 4.

In the first place, the job order is analyzed in the job-order analysis section 11 when a user selects the job order shown in FIG. 4 and required information is supplied to the UI generation section 12 and the parameter management section 14.

Since the type for the “scan” operation which has been described in the job order is a function of “scan” which has been provided in the multiple function device 10 beforehand, pieces of data on the scanning operation screen 70 which have been stored beforehand are read out in the UI generation section 12.

Furthermore, the parameter value of the “color” on the scanning operation screen 70 is set to “true” in the UI generation section 12, as the default value of the “color” of the job order is “true”.

Thereby, the scanning operation screen 70 generated in the UI generation section 12 may be displayed on the control panel 13.

(Generation of Document Registration Operation Screen 80)

The document registration operation screen 80 is generated as follows based on the job order shown in FIG. 4.

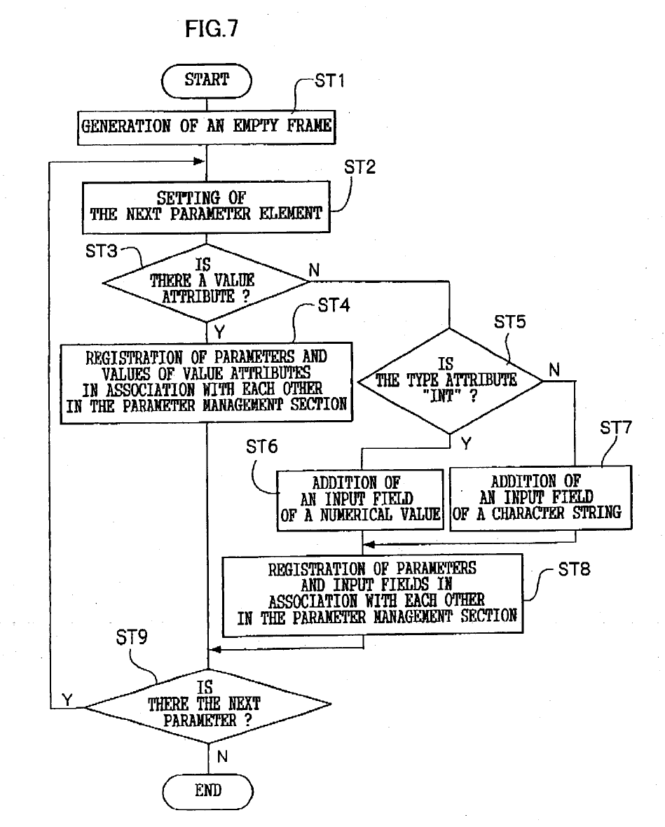

FIG. 7 is a flow chart showing a processing procedure by which the document registration operation screen 80 is made in the UI generation section 12.

At STEP ST1, an empty frame, that is, an empty document registration operation screen 80 is made in the UI generation section 12, since the “type” of the “AddDocument” operation is “SOAP”, and, then, the processing proceeds to STEP ST2.

At STEP ST2, a parameter element of the “AddDocument” operation to be processed in the next place is set in the UI generation section 12 as an object to be processed, and, then, the processing proceeds to STEP ST3.

For example, the “AddDocument” operation has four parameters of “document”, “keyword”, “userid”, and “isLandscape”, as shown in FIG. 4. Then, in the first place, for example, “document” is set in the UI generation section 12 as an object to be processed. In the second place, “keyword” is set as an object to be processed when processing of “document” has been already completed. Similarly, in the third place. “userId”, and, in the fourth place, “isLandscape” are set as an object to be processed, respectively.

In order to determine whether input by a user for the parameter to be processed is required or not, it is determined at STEP ST3 in the UI generation section 12 whether there is a value attribute or not. Then, when there is the value attribute, the processing proceeds to STEP ST4, and when there is no value attribute, the processing proceeds to STEP ST5.

As shown in FIG. 4, the parameters “document” and “isLandscape” have a value attribute, The value attribute of “document” is “&scannedFileLocation” which indicates a saving end of a scanned image. Moreover, the value attribute of “isLandscape” is “/scan/isLandscape”. This means the isLandscape parameter of the scanning operation screen 70. Accordongly, the above two parameters do not require input by a user. Thereby, input items based on the above-described two parameters are not added to the empty frame.

On the other hand the parameters “keyword” and “userid” do not have the value attribute. Accordingly, a user is required to input the above two parameters. Thereby, input items based on the above-described two parameters are added to the empty frame as described later.

At STEP ST4, the UT generation section 12 registers the parameters to be processed and the values of the value attributes in association with each other in the parameter management section 14 and the processing proceeds to STEP ST9.

On the other hand, it is determined at STEP ST5 in the UI generation section 12 whether the type attribute of the parameter to be processed is “int” or not. Then, the processing proceeds to STEP ST6 when the type attribute is “int” and the processing proceeds to STEP ST6 when the type attribute is not “int”, that is, when the type attribute is “string”.

At STEP ST6, the UI generation section 12 adds an input field of a numerical value (for example, the userID field 82 in FIG. 6) to the empty frame generated at STEP ST1, as the numerical value of the parameter to be processed is required to be input. Then, the processing proceeds to STEP ST8.

At STEP ST7, an input field of a character string (for example, the keyword field 81 in FIG. 6) is added in the UI generation section 12 to the empty frame generated at STEP ST1, as the parameter to be processed requires input of the character string. Then, the processing proceeds to STEP ST8.

At STEP ST8, the parameter to be processed and the added input fields are registered by the UI generation section 12 in association with each other in the parameter management section 14 and the processing proceeds to STEP ST9. Thereby, it becomes possible for the parameter management section 14 to store the input values and the parameter in association with each other when the character string and the numerical value are input into the input fields, respectively.

At STEP ST9, it is determined in the UI generation section 12 whether there is, among parameters for the “AddDocument” operation, a parameter to be processed in the next place. Then, the processing returns to STEP ST2 when there is a parameter to be processed in the next place, and the processing is completed when there is no parameter to be processed below.

And, steps from STEP ST2 through STEP ST9 are repeated in the UI generation section 12 until all parameters for the “AddDocument” operation are processed. Thereby, the document registration operation screen 80 generated in the UI generation section 12 may be displayed on the control panel 13.

(Input into DB Registration Operation Screen 60)

Then, a case in which a user executes input into the DB registration operation screen 60 will be explained. Here, it is assumed that the user does not change the default values on the scanning operation screen 70 and inputs a character string and a numerical value into the document registration operation screen 80.

In the first place, it is assumed that the user inputs a character string into the keyword input field 81, but enters nothing into the userID field 82.

A character string “sample” is stored in the parameter management section 14 in association with the parameter “keyword” when, for example, the character string “sample” is input into the keyword input field 81. Then, the control section 19 makes the constraint checking section 15 check constraints for the parameters when it is detected in the control section 19 that the user pushes the start button 92.

Here, each parameter “scan” or “AddDocument” in the job order has a must attribute by which it is shown whether the parameter can be eliminated or not. Subsequently, the constraints for each parameter described in the job order are checked in the constraint checking section 15.

For example, the must attribute for the parameter “userId” is “true”, that is, it is shown that the parameter can no be eliminated. On the other hand, it is assumed that a user presses the start button 92 after the user inputs a character string into the keyword input field 81 and nothing to the userID field 82. Thereby, in order to press the user for input of the user ID, the constraint checking section 15 makes the control panel 13 execute error display by which it is shown that the user ID has not yet been input.

Subsequently, it is assumed that a user inputs “1234” into the userID field 82 after the control panel 13 executes the error display.

A numerical value “1234” is stored in the parameter management section 14 in association with the parameter “userID” when the numerical value “1234” is input into the userID field 82. Then, the control section 19 makes the constraint checking section 15 check constraints for the parameters when it is detected that the user pushes the start button 92. At this time, the constraint checking section 15 does not make the control panel 13 execute the error display.

A first “scan” operation is executed in the control section 19 when it is determined at constraint check of the parameters in the constraint checking section 15 that there is no error.

In the first place, the parameter management section 14 supplies the value of the parameter for the “scan” operation to the scanning execution section 17. A paper document is read in the scanning execution section 17 to generate document data which is supplied to the file transfer section 18.

The file transfer section 18 saves the scanned image in a location which is specified by the parameter “destination”. Moreover, the values of parameters which have been automatically obtained by consecutive pieces of processing or the values of changed parameters (for example, the value of “&scannedFileLocation”) are rewritten into the original values in the scanning execution section 17, respectively.

A “AddDocument” operation to be processed in the next place is executed in the control section 19 when the first “scan” operation is completed.

As shown in FIG. 4, the type attribute of the “AddDocument” is “SOAP”. Thereby, in the parameter management section 14, operations, which are specified by name attributes provided from services described in the WSDL (Web Service Description Language) specified by Location attributes, are instructed, by supplying parameters of the “AddDocument” to the SOAP calling section 16, to be executed.

The specified WSDL is acquired through the network 5 in the SOAP calling section 16. A structure of a request message by which the operation with the specified name is called is described in the WSDL. Then, in the SOAP calling section 16, the value of a parameter with a corresponding name is extracted from the values of the given parameters and the SOAP request message is made.

In the SOAP calling section 16, the request message made as described above is transmitted according to the SOAP protocol to an address (for example, the service processing device 40) specified by the WSDL. On the other hand, a request is executed in the service processing device 40, that is, the message is registered as a file in the service processing device 40 in which documents are saved in a retrievable manner.

When transmission of the SOAP message is completed in the SOAP calling section 16, the completion of the processing is notified from the section 16 to the control section 19.

As described above, consecutive pieces of processing which comprise pieces of processing at the multiple function device 10 and those at other external service processing devices may be executed by simple operations in the document processing network system 1 according to the first embodiment, as the consecutive pieces of processing are defined in the job order.

Especially, not only the parameters for pieces of processing in the multiple function device 10 itself, but also those for pieces of external processing may be specified in the multiple function device 10 through the operation screens of the control panel 13. At this time, operation screens with superior expandability may be presented, as the operation screens for the external processing are not required to be installed in the multiple function device 10 beforehand and operation screens corresponding to functions of external services are dynamically generated based on job orders.

Also, the multiple function device 10 may have a configuration in which a plurality of job orders have been stored in a not-shown storage section beforehand and a job order which a user desires is selected from the job orders which have bee stored. Alternatively, the multiple function device 10 may be configured so that job orders which have been stored in other service processing devices connected to the multiple function device 10 through the network 5, or job orders which have been obtained from unspecified service processing devices by retrieval are used.

Though a case in which a scanning service is applied as one of services provided by the multiple function device 10 has been explained as an example in the present embodiment, services such as transmitting and receiving by facsimile, and outputting of images and log information, other than the scanning service, may be applied. But, the services to be provided are not limited to the above-described examples. Also, the number of the service processing devices which are connected to the network 5 is not limited.

Though a case in which the service processing device 40 executes processing after the multiple function device 10 completes processing has been explained in the present embodiment, another reversing case in which the multiple function device 10 executes processing after the service processing device 40 completes processing may be applied. Thereafter, other external service processing devices may be obviously configured to further execute processing. That is, the contents of linking processing have no limitation.

Also, there maybe applied another configuration in which processing is executed in the multiple function device 10 not by a command from a user through the operation screen, but, for example, processing which is described in a job order included in a document obtained through facsimile is started on receiving the document. According to further another possible configuration, a job order attached in an electronic mail is analyzed on receiving the mail, and processing which is described in the job order is started.

[Second Embodiment]

Next, a second embodiment according to the invention will be explained. Here, elements similar to those in the first embodiment are denoted by the same reference numerals as those in the first embodiment, and detailed description will be omitted. A document processing network system 1 according to the second embodiment has the same configuration as that of FIG. 1.

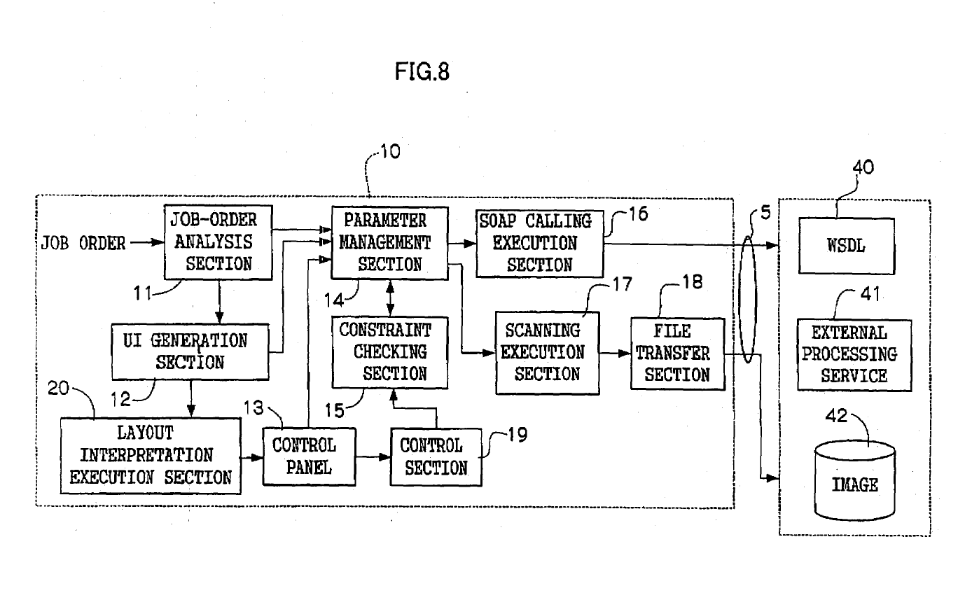

FIG. 8 is a block diagram showing a functional configuration of a multiple function device 10 according to the second embodiment. The multiple function device 10 further comprises a layout interpretation execution section 20 in addition to the configuration shown in FIG. 2. The layout interpretation execution section 20 comprises, for example, a web browser and a layout is interpreted for layout display based on an UI generated in a UI generation section 12.

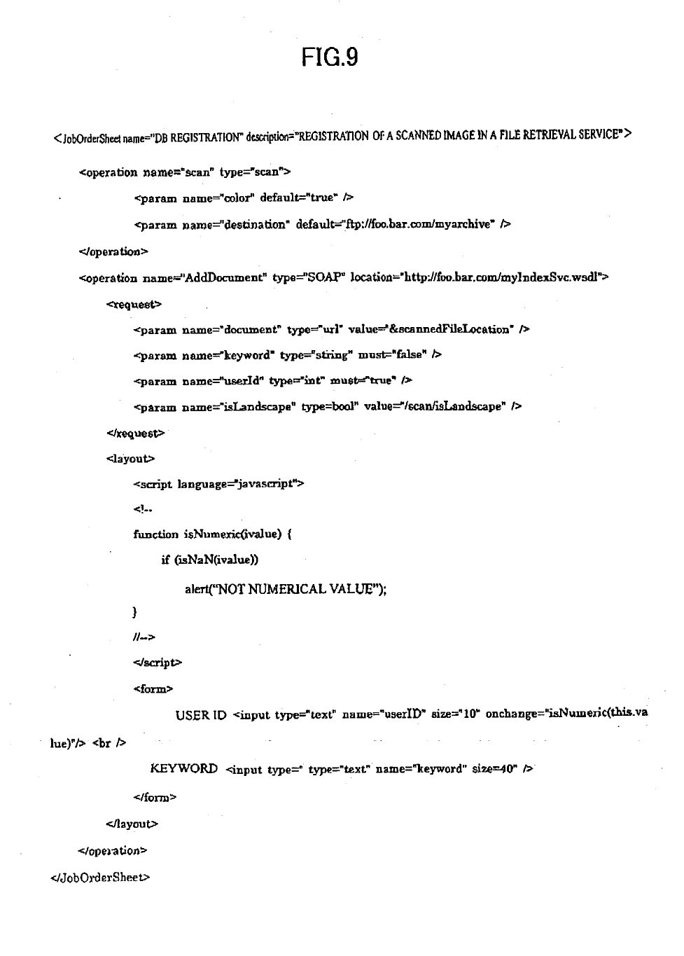

FIG. 9 is a view showing a job order, which is made in an XML format, according to the second embodiment. It is described in the above job order that two pieces of processing of “scan” and “AddDocument” are executed in the above-written order. The “AddDocument” has a <layout> element that is layout information on an operation screen.

A <layout> element is described, for example, in a format according to HTML (HyperText Markup Language) and, moreover, constraint information described in JavaScript (a registered trademark of the SunMicrosystems) language is embedded therein.

A scanning operation screen 70 is generated as follows based on the job order as configured above.

In the first place, a job-order analysis section 11 analyzes the job order and supplies required information to the UI generation section 12 and a parameter management section 14 when a user selects the job order shown in FIG. 9.

Data of the scanning operation screen 70 which has been stored beforehand is read out in the UI generation section 12 for the “scan” operation described in the job order, because the type of the “scan operation” is “scan” which indicates a function that has been provided in the multiple function device 10 beforehand. Moreover, the parameter value of “color” in the scanning operation screen 70 is set as “true” in the UI generation section 12, as the default value of “color” in the job order is “true”.

Also, a document registration operation screen 80 is generated as follows based on the above-described job order.

As the type for the “AddDocument” operation is “SOAP” and the operation has the <layout> element, the <layout> element is interpreted, using the layout interpretation execution section 20, and the document registration operation screen 90 is generated in the UI generation section 12, as shown in FIG. 6.

The layout interpretation execution section 20 comprises a so-called web browser and the above-described document registration operation screen 80 is generated in the section 20, using the processing result in the UI generation section 12.

Accordingly, a DB registration operation screen 60 comprising two screens of the scanning operation screen 70 and the document registration operation screen 80 is displayed on a control panel 13. Here, a user may switch the display screen between two screens by touching a tab for the scanning operation screen 70 or one for the document registration operation screen 80.

(Input into DR Registration Operation Screen 60)

Next, a case in which a user executes input into the DB registration operation screen 60 will be explained. Here, it is assumed that the user does not change the default values on the scanning operation screen 70 and inputs a character string and a numerical value into the document registration operation screen 80.

Here, it is assumed that the user inputs not a numerical value, but, for example, “abc” into an userID field 82 by operating a document registration operation screen 80. Then, isNumeric( ) which is associated with the user ID field 82 is executed by javascript embedded in the document registration operation screen 80. Thereby, it is checked whether a value which is input into the user ID field 82 is a numerical value or not. In this case, an error message is displayed on the DB registration operation screen 60 by an alert ( ) method, as the value is not a numerical value.

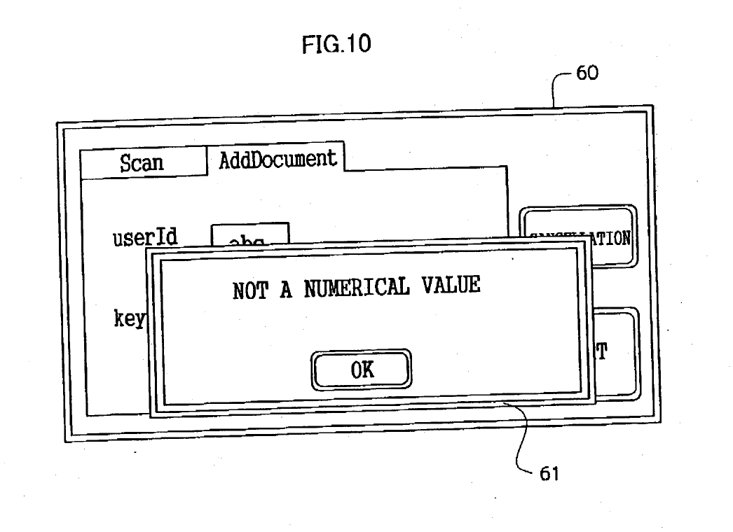

FIG. 10 is a view showing an error message 61 displayed on the DB registration operation screen 60.

Then, it is assumed that a user inputs, for example, “1234” into the userID field 82. Then, IsNumeric ( ) is executed by javascript embedded in the document registration operation screen 80. In this case, an error message is not displayed on the DB registration operation screen 60, as the value is a numerical value.

When the user instructs execution, an input value of the parameter is acquired in the parameter management section 14 from <input> objects with name attributes corresponding to the operation screens. A scanning operation and a calling operation of external processing are executed in the constraint checking section 15 after checking constraint conditions described in the job order. Here, the detailed explanation will be omitted, as this processing is the same as that of the first present embodiment.

As described above, according to the document processing network system 1 of the present second embodiment, an operation screen may be generated in the multiple function device 10 in accordance with the layout information described in the job order by providing the layout interpretation execution section 20.

Moreover, a user friendly operation screen with attractive looking and excellent operability may be provided in the multiple function device 10 even when an operation linked with an external service is instructed, as an operation screen which is generated by interpretation of a program described in a script language is embedded in an operation screen which has been provided in the body of the multiple function device 10 as one function beforehand.

Here, though the configuration in which the display screen is switched between the basic-function operation screen which is provided in the main body of the device 10 and an operation screen of a service which is generated according to the layout information on the service described in the job order by touching a tab has been applied in the present embodiment, another configuration in which operation screens according to various kinds of aspects are provided for example, a configuration in which parameters which are common to those for a basic-function operation screen and those for an operation screen of a service are displayed in a common screen, or a configuration in which a basic-function operation screen and an operation screen of a service are simultaneously displayed, can be applied.

[Third Embodiment]

Then, a third embodiment according to the invention will be explained. Here, elements similar to those in the above-described embodiments are denoted by the same reference numerals as those in the above embodiments, and detailed description will be omitted. A document processing network system 1 according to the third embodiment has the same configuration as that of FIG. 1.

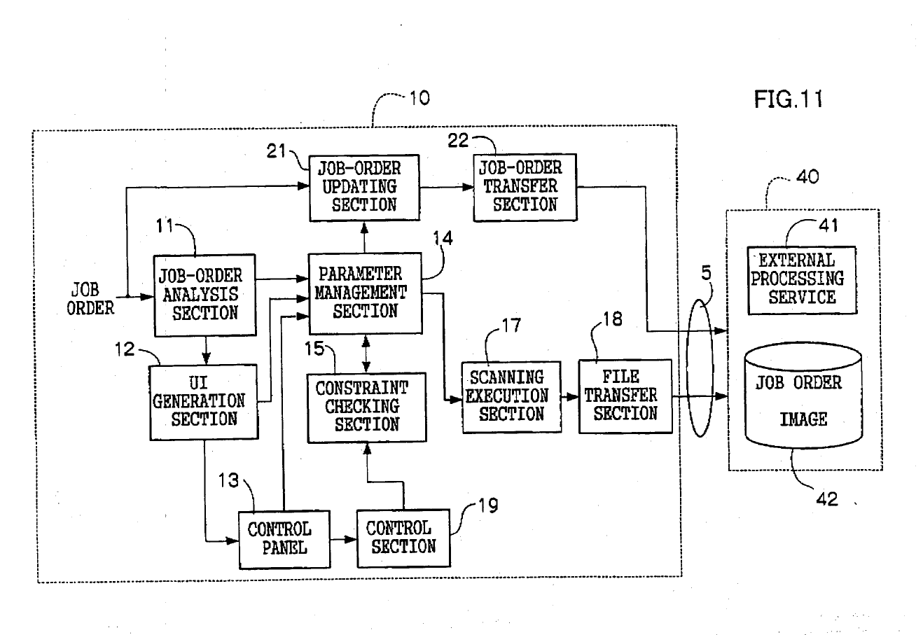

FIG. 11 is a block-diagram showing a functional configuration of a multiple function device 10 according to the third embodiment. The multiple function device 10 has a configuration in which the SOAP calling section 16 is excluded from the configuration shown in FIG. 2 and a job-order updating section 21 which updates a job order and a job-order transfer section 22 which transfers a job order are newly added to the configuration shown in FIG. 2.

The multiple function device 10 according to the present embodiment links with processing in other service processing devices by a configuration in which an operation screen is generated based on the job order and a job order which has been updated with a value input by a user through the operation screen or with a value obtained as a processing result is transferred to the other service processing devices.

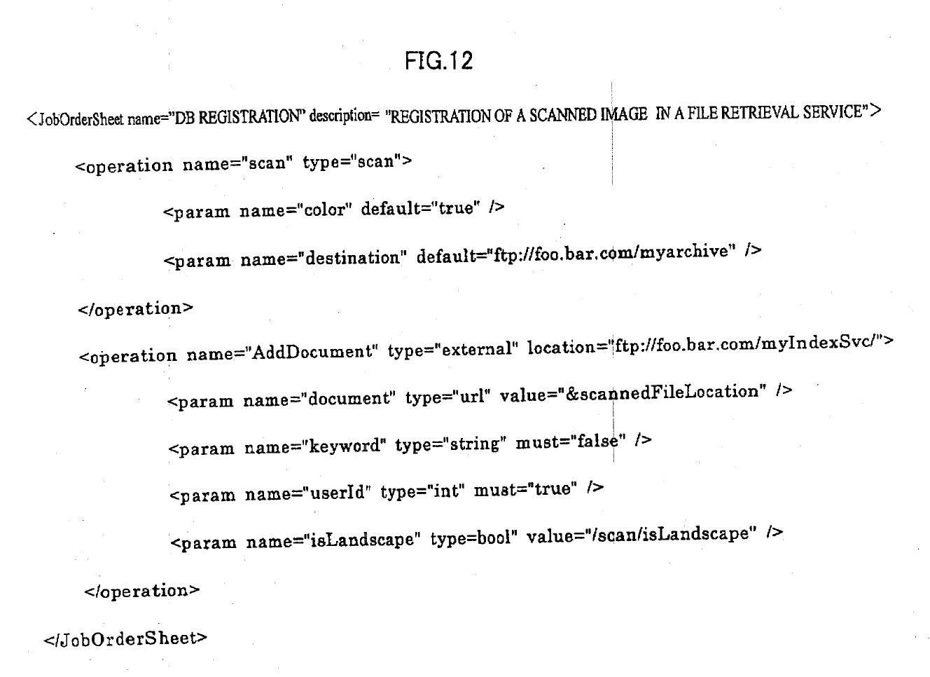

FIG. 12 is a view showing the job order, which is made in an XML format, according to the third embodiment. In the case of the above job order, the type attribute of a first operation is “scan”. The type attribute of a second operation is “external”. The location attribute is “ftp://foo.bar.com/myIndexSvc/”.

The above-described job order means that linked processing is executed by a configuration in which the updated job order in transferred to “ftp://foo.bar.com/myIndexSvc/” after the sheet is scanned in the multiple function device 10 and the updated job order is interpreted and predetermined processing is executed according to the contents of the sheet in a service processing device as the transferred end.

Here, the present configuration has the same configuration as that of the above-described embodiments until execution is instructed and scanning of the first operation is executed after the operation screen is generated based on the job order, and a user confirms the value of a parameter or a user changes the value of a parameter.

The control section 19 makes the job-order updating section 21 update the job order after completion of scanning in a scanning execution section 17.

Specifically, parts related with completed processing is deleted from the job order in the job-order updating section 21 and the job order is updated so that the results obtained by inputs by users and by processing are reflected in the job order. Then, the updated job order is transferred to a specified location in the job-order transfer section 22.

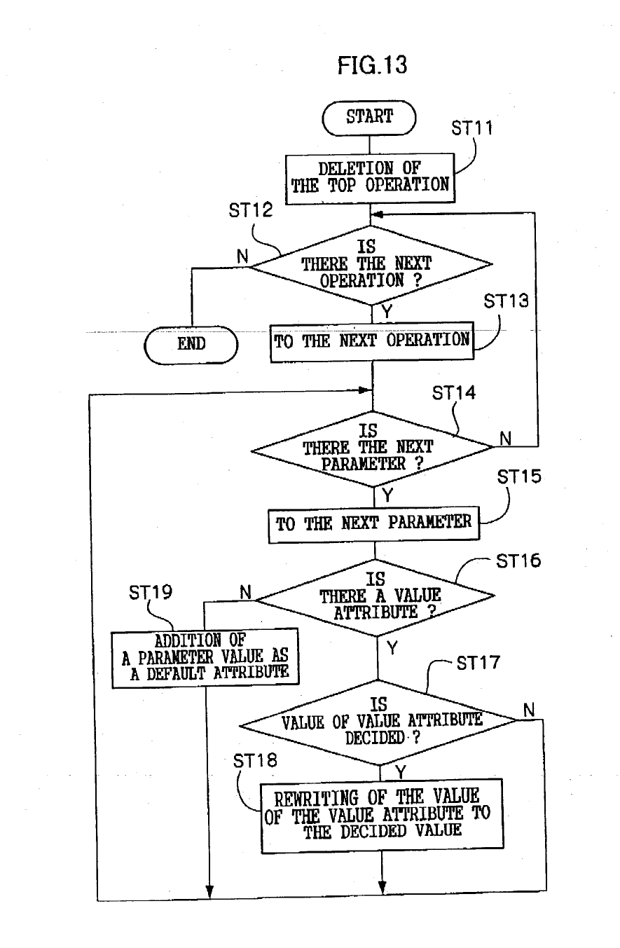

FIG. 13 is a flow chart showing a processing procedure by which the job order is updated in the job-order updating section 21.

At STEP ST11 an operation node (for example, “scan”) which has been already completed is deleted in the job-order updating section 21 from the operation nodes, which have been described in the job order and the processing proceeds to STEP ST12.

It is determined at STEP ST12 in the job-order updating section 21 whether there is an operation to be processed in the next place, that is, whether an operation to be processed below exists. Then, the processing proceeds to STEP ST13 when there is the operation to be processed in the next place and the processing is completed when there is no operation to be processed below.

At STEP ST13, an operation to be processed in the next place is set in the job-order updating section 21 as an object to be processed and the processing proceeds to STEP ST14.

It is determined in the job-order updating section 21 at STEP ST14 whether there is a parameter, among parameters for the related operation, to be processed in the next place, that is, whether there is a parameter which has not been processed. Then, the processing proceeds to STEP ST15 when there is the parameter to be processed in the next place and the processing returns to STEP ST12 when there is no parameter to be processed below, as processing for all parameters concerning the related operation is completed.

At STEP ST15 a parameter to be processed in the next place is set in the job-order updating section 21 as an object to be processed and the processing proceeds to STEP ST16.

It is determined at STEP ST16 in the job-order updating section 21 whether there is a value attribute or not. Then, the processing proceeds to STEP ST17, when there is the value attribute and the processing proceeds to STEP ST19 when there is no value attribute.

It is determined at STEP ST17 in the job-order updating section 21 whether the value of the value attribute is decided or not. Then, the processing proceeds to STEP ST18 when the value is decided and the processing returns to STEP ST14 when the value is not decided.

The value of the value attribute is rewritten into the decided value at STEP ST18 in the job-order updating section 21 and the processing returns to STEP ST14.

On the other hand, the value of the parameter is added as a default attribute in the job-order updating section 21 at STEP ST19 and the processing returns to STEP ST14.

In the job-order updating section 21, the following processing is executed for an “AddDocument” operation described in the job order shown, for example, in FIG. 12.

A first parameter node “document” specifies, as a value attribute. “&scannedFileLocation” which means a location of a scanned image file. This value has been already decided by scanning. Then, the value is rewritten into, for example, “ftp://foo.bar.com/myarchive/tmp1234.tiff” in the job-order updating section 21.

A parameter node “keyword” to be processed in the next place has no value attribute. Then, a value, for example, “sample”, which was input by a user and has been stored in the parameter management section 14 is added as a default attribute in the job-order updating section 21.

Similarly, a parameter node “userId” to be processed in the next place has no value attribute. Then, a value, for example, “1234”, which was input by a user and has been stored in the parameter management section 14 is added as a default attribute in the job-order updating section 21.

A parameter node “isLandscape” to be processed in the next place has a value attribute of a “/scan/isLandscape” which means a “isLandscape” parameter on the scanning operation screen 70. This value has been decided from a time point when execution of the above-described scanning was started. Then, the value of the value attribute is rewritten into, for example, “true” in the job-order updating section 21.

Since there is neither a parameter node, nor an operation node to be processed in the next place in the job order after the above-described processing is executed with regard to the job order, rewriting operation of the job order is completed in the job-order updating section 21.

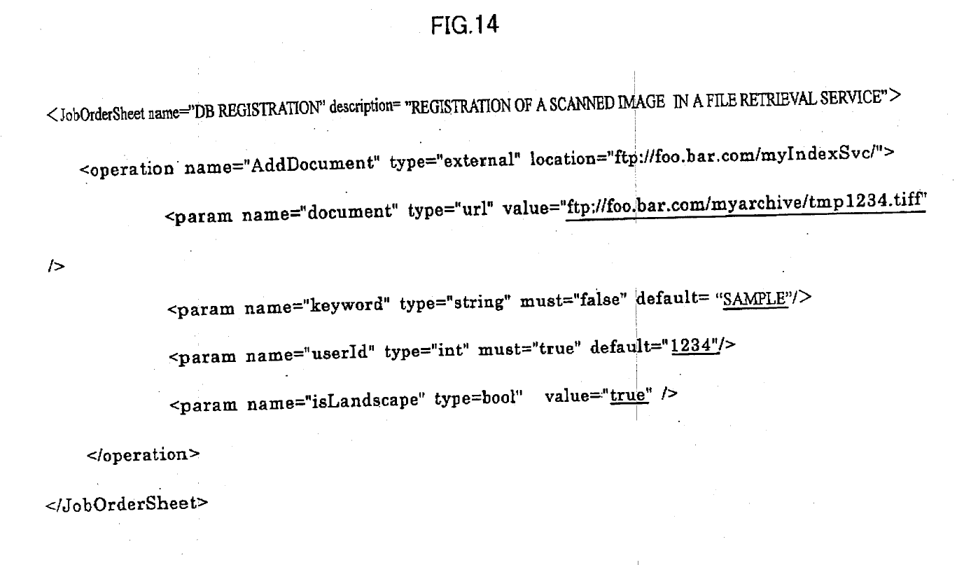

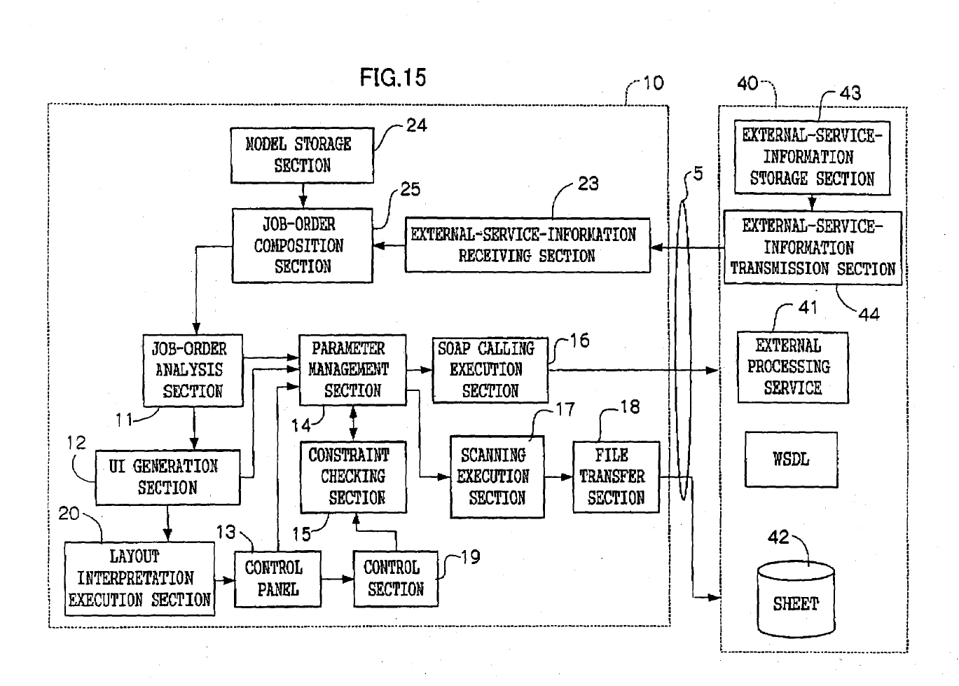

FIG. 14 is a view showing the job order, which is rewritten in the job-order updating section 21. In the job-order transfer section 22, the job order rewritten in the job-order updating section 21 is transferred for saving to a location specified by “location”.

As described above, the operation screen is made based on the job order; the job order is updated through the operation screen based on a value specified by a user; and the updated job order is transferred to other service processing devices in the document processing network system 1 according to the third embodiment. And, then the updated job order is interpreted and processing is executed in the other service processing devices according to the contents of the sheet.

Thereby, not only the parameters for pieces of processing in the multiple function device 10, but also those for pieces of processing in other service processing devices may be specified in the document processing network system 1 through the operation screens of the control panel 13 of the multiple function device 10 while the consecutive pieces of processing which comprise pieces of processing at the multiple function device 10 and those at other external service processing devices are executed. Furthermore, operation screens with superior expandability may be presented, as the operation screens for processing in the other service processing devices are not required to be installed in the multiple function device 10 beforehand.

[Fourth Embodiment]

Next, a fourth embodiment according to the invention will be explained. Here, elements similar to those in the above-described embodiments are denoted by the same reference numerals as those in the above embodiments, and detailed description will be omitted. Here, a document processing network system 1 according to the fourth embodiment has the same configuration as that of FIG. 1.

FIG. 15 is a block diagram showing a functional configuration of a multiple function device 10 according to the fourth embodiment. The multiple function device 10 has a configuration in which an external-service-information receiving section 23 which receives external service information, a model storage section 24 in which a model of a job order is stored, and a job-order composition section 25 which composes a job order using external service information are further included in addition to the configuration shown in FIG. 8.

On the other hand, a service processing device 40 has, as shown in FIG. 15, a configuration in which an external-service-information storage section 43 which stores external service information, and an external-service-information transmission section 44 which transmits the external service information stored in the external-service-information storage section 43 according to requirement from the multiple function device 10 are further included in addition to the configuration shown in FIG. 8.

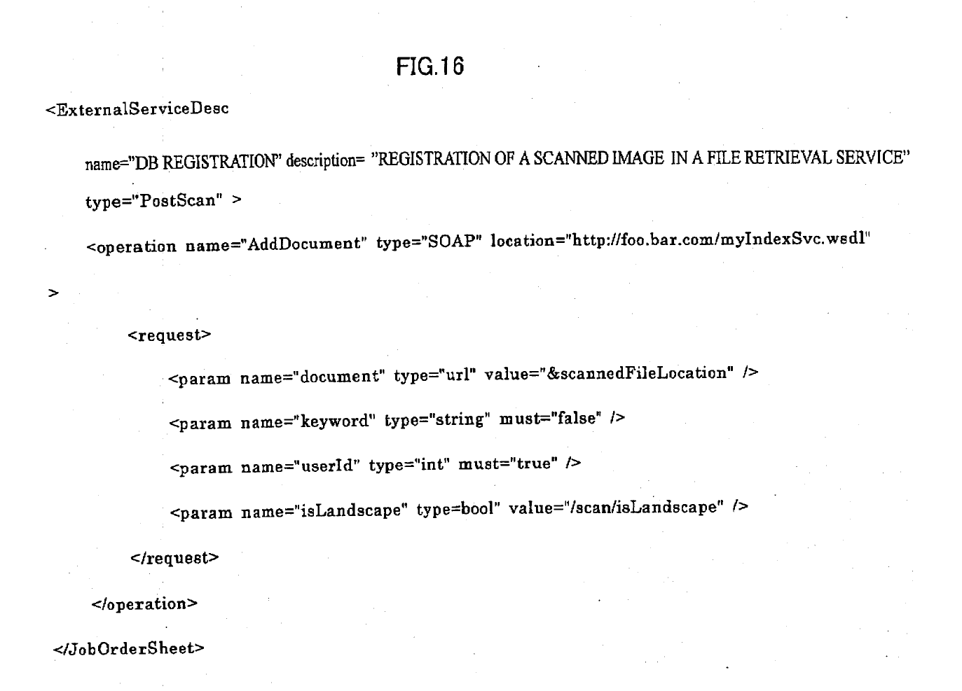

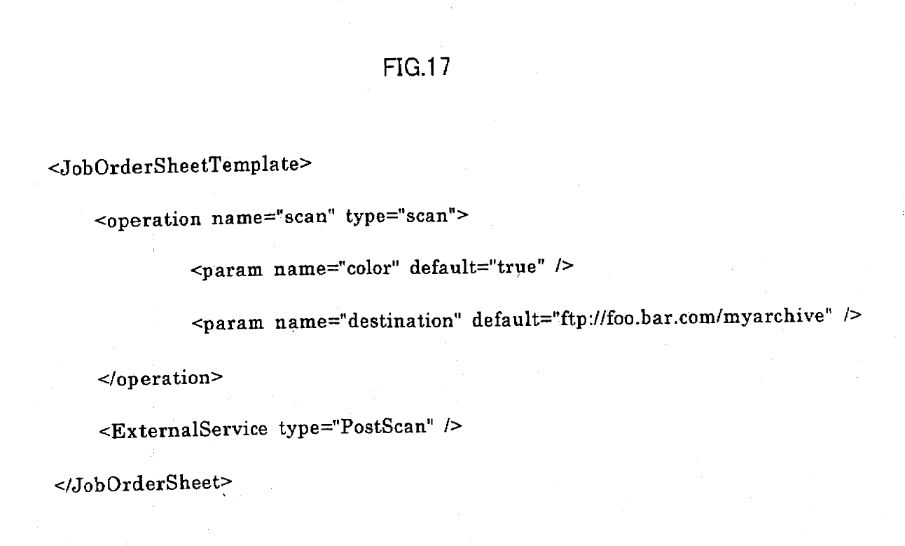

FIG. 16 is a view showing external service information. FIG. 17 is a view showing the model of the job order.

When a command, by which retrieval or acquisition of external service information for a service desired by a user is started, is received from the user through a control panel 13, a control section 19 makes the external-service-information receiving section 23 start execution of the processing.

The external-service-information receiving section 23 requests transmission of the external service information to the service processing device 40. Thereafter, the external service information is supplied from the external-service-information receiving section 23 to the job-order composition section 25 when the external service information transmitted from the service processing device 40 is received in the section 23.

In the job-order composition section 25, the job order is generated by composition of the external service information supplied from the external-service-information receiving section 23 and the model which has been stored beforehand. Specifically, it is confirmed in the job-order composition section 25 that the external service information and the model can be composed, because the type attribute of the external service information and that of an External service node of the model are found to correspond to each other based on the fact that the both are “PostScan”. Here, composing processing is not executed in the job-order composition section 25 when both of the type attributes do not correspond to each other.

In the job-order composition section 25, a node name of “JobOrderSheetTemplate” of the model is rewritten into “JobOrderSheet” and the name attribute and the description attribute of the external service information are copied to those of the model after it is confirmed that the external service information and the model can be composed. In addition, the External service node is replaced with the operation node of the external service information.

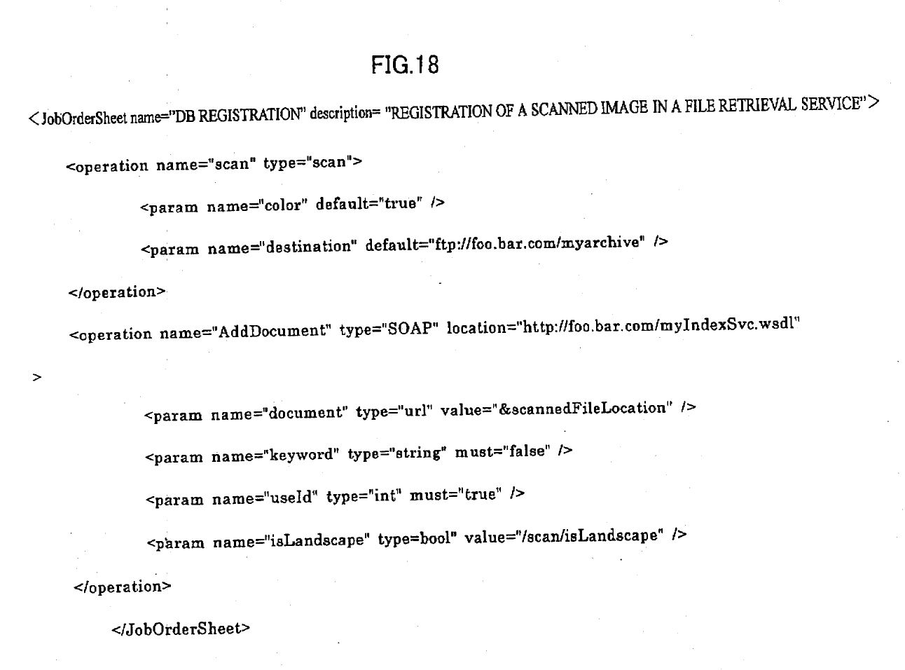

FIG. 18 is a view showing the job order, which has been generated in the job-order composition section 25. The job-order composition section 25 supplies the job order generated by the above-described processing to a job-order analysis section 11. Here, the operation screen is displayed based on the job order, in a similar manner to that of the above-described embodiments.

As described above, the external service information is acquired in the multiple function device 10, as required, and the operation screen may be dynamically generated based on the acquired external service information, according to the document processing network system 1 of the fourth embodiment. Accordingly, processing linked with other service processing devices may be executed in the multiple function device 10 only by receiving new external service information in order to generate the job order.

Also, not only the parameters for processing in the multiple function device 10, but also those for external processing in other service processing devices may be specified in the multiple function device 10 through the operation screen of the control panel 13. Furthermore, the multiple function device 10 may have a configuration in which operation screens for the external processing are not required to be installed beforehand, job orders are generated only by received external service information, and operation screens with superior expandability may be presented based on the generated job order.

Also, the multiple function device 10 may have another configuration in which only the job order which the related user can use may be selected from the stored job orders based on user information which is input through the operation screen of the control panel 13. In addition, the device 10 may have still another configuration in which user information is transmitted to an external server, external service information which the related user can use is retrieved, and the retrieved external service information is received. By the above configurations, a user does not need to worry about whether the service is allowed to use or not, because services which a user can not use are not displayed.

Here, though the present embodiment has had a configuration in which the service processing device 40 by which external services are provided comprises the external-service-information transmission section 44, the multiple function device 10 comprises the external-service-information receiving section 23, and the external-service-information receiving section 23 directly acquires external service information from each service processing device, the invention is not limited to the above one. For example, another configuration in which a server which manages external service information is provided and the multiple function device 10 indirectly acquires external service information from the server may be applied.

Further, though a case in which the multiple function device 10 presents operation screens with expandability has been explained as an example in the above first through fourth embodiments, it is obvious that other service processing devices may present operation screens with expandability in a similar manner to that of the device 10.

What is claimed is:

1. An operation-screen display device comprising:
a job-order storage section which stores a job order, in which processing information by which one or more pieces of processing applied to document data are expressed as consecutive pieces of processing, and one or more parameters which respectively set an execution of each of the pieces of processing are described; and
an operation-screen display section which displays an operation screen in order to set at least one parameter which is described in the job order stored in the job-order storage section.

2. An operation-screen display device according to claim 1, further comprising:
a parameter setting section which sets a parameter described in the job order through the operation screen displayed on the operation-screen display section; and
a processing execution section which executes the processing based on the job order which has been stored in the job-order storage section and on the parameter set in the parameter setting section.

3. An operation-screen display device according to claim 1, wherein:
the job-order storage section stores the job order in which layout information for the operation screen is further described; and
the operation-screen display section displays the operation screen based on the layout information of the job order.

4. An operation-screen display device according to claim 2, further comprising:
a job-order updating section which updates the job order based on a result of the processing executed by the processing execution section; and
a job-order transfer section which transfers the job order that has been updated by the job-order updating section to an execution location of a next piece of processing.

5. An operation-screen display device according to claim 1, further comprising:
a model storage section which stores a model of the job order;
an external-processing-information receiving section in which receives external processing information expressing a content of processing which is applied to document data by a processing device; and
a job-order generation section which generates the job order through which consecutive pieces of processing are executed in association with the processing device based on the model stored in the model storage section and the external processing information received by the external-processing-information receiving section.

6. An operation-screen display method comprising:
a job-order storage step of storing a job order in which processing information expressing one or more pieces of processing applied to document data as consecutive pieces of processing, and one or more parameters which respectively set an execution content of each of the pieces of processing are described; and
an operation screen display step of displaying an operation screen in order to set at least one parameter which is described in the job order stored at the job-order storage step.

7. An operation-screen display method according to claim 6, further comprising;
a parameter setting step of setting a parameter described in the job order through the operation screen displayed at the operation screen display step; and
a processing execution step of executing the processing based on the job order stored at the job-order storage step and on the parameter set at the parameter setting step.

8. An operation-screen display method according to claim 6, wherein:
the job order in which layout information for the operation screen is further included is stored at the job-order storage step; and
the operation screen is displayed at the operation-screen display step based on the layout information of the job order.

9. An operation-screen display method according to claim 7, further comprising:
a job-order updating step of updating the job order based on a result of the processing executed at the processing execution step; and
a job-order transfer step of transferring the job order updated at the job-order updating step to an execution location of a next piece of processing.

10. An operation-screen display method according to claim 6, further comprising:
an external-processing-information receiving step of receiving external processing information expressing a content of processing applied to document data by a processing device is received; and
a job-order generation step of generating a job order through which consecutive pieces of processing are executed in association with the processing device based on a model stored in advance and the external processing information received at the external-processing-information receiving step.

11. A recording medium containing an operation-screen display control program for causing a computer to execute processing comprising an operation screen display step of displaying an operation screen based on a job order which describes processing information expressing one or more pieces of processing applied to document data as consecutive pieces of processing, and one or more parameters which respectively set an execution content of each of pieces of processing, in order to set at least one parameter which is described in the job order.

12. A recording medium according to claim 11, wherein the program causes a computer to execute processing which further comprises:
a parameter setting step of setting a parameter described in the job order through the operation screen displayed at the operation screen display step: and
a processing execution step of executing the processing based on the job order and on the parameter set at the parameter setting step.

13. A recording medium according to claim 11, wherein
the operation screen is displayed at the operation-screen display step based on the job order in which layout information for the operation screen is further described.

14. A recording medium according to claim 12, wherein
the program causes a computer to execute processing which further comprises:
a job-order updating step of updating the job order based on a result of the processing executed at the processing execution step; and
a job-order transfer step of transferring the job order updated at the job-order updating step to an execution location of a next piece of processing.

15. A recording medium according to claim 11, wherein the program causes a computer to execute processing which further comprises:
an external-processing-information receiving step of receiving external processing information expressing a content of processing applied to document data by a processing device;
a job-order generation step of generating the job order through which consecutive pieces of processing are executed in association with the processing device based on a model stored in advance and the external processing information received at the external-processing-information receiving step.
